(19) United States
(12) Patent Application Publication
(10) Pub. No.: US 2005/0206575 A1
(43) Pub. Date: Sep. 22, 2005

(54) Dual polarisation antenna

(76) Inventors: Peter Eric Chadwick, Wellington (NZ); Mathias Martin Ernest Ehien, Upper Hunt (NZ); Peter Bruce Graham, Martinborough (NZ); Arthur George Roberts, Wellington (NZ)

Correspondence Address: WELSH & KATZ, LTD, 120 S RIVERSIDE PLAZA, 22ND FLOOR, CHICAGO, IL, 60606, US

(21) Appl. No.: 10/450,480

(22) PCT Filed: Dec. 20, 2001
(86) PCT No.: PCT/NZ01/00293

§ 371 Date: Dec. 27, 2004

(30) Foreign Application Priority Data
Dec. 21, 2000 (NZ) 509097

(51) Int. Cl. H01Q 21/26

(52) U.S. Cl. 343/797

(57) ABSTRACT

A dual polarisation antenna comprising: one or more radiating elements (20); a pair of side walls (11,12) arranged on opposite sides of the radiating element(s); and one or more conductive isolating elements (44, 51, 70, 40, 41), each isolating element being at least partially supported by one or both of the side walls.

The present invention relates to a dual polarisation antenna.

A conventional dual polarisation antenna is described in U.S. Pat. No. 6,072,439. A pair of side walls are arranged on opposite sides of a line of six crossed-dipole radiating elements. In one embodiment the side walls are C-shaped in cross-section and have edges which create a diffraction pattern that increases the beamwidth by approximately ten degrees compared to similar antennas with no side walls. In another embodiment the side walls are L-shaped in cross-section and narrow the 3 dB beamwidth of the antenna compared to similar antennas with no sidewalls. A single parasitic isolation element is located midway along the length of the line of dipole radiating elements.

An alternative antenna arrangement is described in U.S. Pat. No. 5,952,983. A line of three cross-dipole radiating elements is provided, with a parasitic element between two of the radiating elements. In one arrangement, the parasitic element is inserted into a groove formed along the top edge of a non-conducting support which extends transversely across the array and is attached to the back plane. In another arrangement, the parasitic element is supported and elevated by pairs of rod supports.

In U.S. Pat. No. 5,940,044, isolation elements in the form of isolation plates of conductive material are disposed between each dipole sub-array. The isolation plates are connected to the back plate by suitable fasteners.

Various different isolation devices are described in U.S. Pat. No. 6,028,653, including isolation trees or bars arranged between bow tie radiating assemblies; isolation rails arranged alongside bow tie assemblies; rods or wires arranged in or on a radome that covers the bow tie assemblies; isolation strips arranged between a positive and negative arm of a dipole of a bow tie assembly; or a combination of one or more of the above.

An object of the invention is to provide an alternative antenna construction incorporating side walls and one or more isolating elements.

The present invention provides a dual polarisation antenna comprising:
one or more radiating elements;
a pair of side walls arranged on opposite sides of the radiating element(s); and
one or more conductive isolating elements, each isolating element being supported by one or both of the side walls.

The invention provides an alternative method of supporting the isolating element(s). In contrast to the prior art discussed above, which uses the back plane to support the isolating element(s), we use the side walls to fully or at least partially support the isolating element(s).

The side walls modify the beam width of the antenna (compared to a similar antenna with no side walls), and the isolating element(s) improve isolation between the two polarisation ports of the antenna.

By using the side walls to support the isolating element(s) we reduce the number of parts compared to U.S. Pat. No. 5,952,983, which requires separate members to support the isolating element.

There may be a continuous conductive connection between the isolating element and the side wall(s). For instance the isolating element may be soldered to one or both of the side walls, or the isolating element and its supporting side wall(s) may be formed integrally from a single piece of conductive material. However a problem with a conductive connection is that in some circumstances, intermodulation distortion may occur at the joint between the element and its supporting side wall(s). Therefore in some embodiments an insulating element is arranged between an isolating element and its supporting side wall. The insulating element may be a strip of tape, or may be an element such as a rivet which passes through a hole in the supporting side wall.

Preferably, the antenna comprises:
two or more radiating elements, each radiating element having first and second opposite sides, and third and fourth opposite sides; and
three or more conductive isolating elements,
wherein the side walls and isolating elements are positioned such that each radiating element faces a side wall on its first side, a side wall on its second side, an isolating element on its third side, and an isolating element on its fourth side.

This provides a more symmetrical arrangement than the arrangement in U.S. Pat. No. 6,072,439. We have found that this added symmetry improves isolation between the two polarisation ports of the antenna.

At a minimum (that is, in the case where only two radiating elements are provided) only three isolating elements are required—one between the radiating elements and one at each end. In the more general case, (that is, where n radiators are provided) n+1 isolating elements will typically be provided (although in some arrangements only n−1 may be required, with the isolating elements at each end omitted).

Typically the radiating elements are arranged in front of a planar reflector. The isolating elements may be partially supported by the reflector (either directly or via an insulating element), or may be fully supported by one or both of the side walls.

The isolating elements may be supported by one of the side walls only. In this case, the element is typically formed as a substantially rectangular tab. The element is preferably directed inwardly: that is, the element subtends an angle of less than 180 degrees with the inner face of its supporting side wall.

Alternatively, the isolating elements(s) may be supported by both side walls.

In one embodiment at least one of the isolating element(s) comprises a rod with a substantially circular cross-section. In another embodiment at least one of the isolating element(s) comprises a wall, which may be connected to the back reflector as well as the two side walls. In another embodiment at least one of the isolating element(s) comprises a strip which is substantially rectangular in cross-section.

In one embodiment the isolating element is formed with a ridge or trough between the two side walls. Preferably the ridge or trough is formed by bending a strip of metal.

The radiating elements may be dipoles, as in U.S. Pat. No. 5,952,983. However, a problem with using dipoles is that they are relatively tall, and therefore the isolating element(s) need(s) to be mounted some distance away from the back reflector. For this reason, in U.S. Pat. No. 5,952,983 the isolating rods are mounted on rod supports. Therefore preferably the radiating elements are patches. Patches generally have a lower profile than dipoles, thus enabling the isolating element(s) to be supported by a side wall at a lower position.

Typically the side walls are substantially continuous (that is—with no slots or holes formed in them).

Typically the side walls are postioned to influence the azimuthal beamwidth of the antenna, for instance to provide an azimuthal beamwidth of 65 degrees.

Typically a plurality of radiating elements are provided, for instance eight. One or more phase shifters may be provided to generate relative phase differences between the elements, for instance to control beam downtilt in a cellular communication system which communicates with mobile devices.

The isolating element(s) may be placed between adjacent radiating elements, and/or aligned with respective radiating elements.

Three embodiments of the invention will now be described with reference to the accompanying drawings, in which:

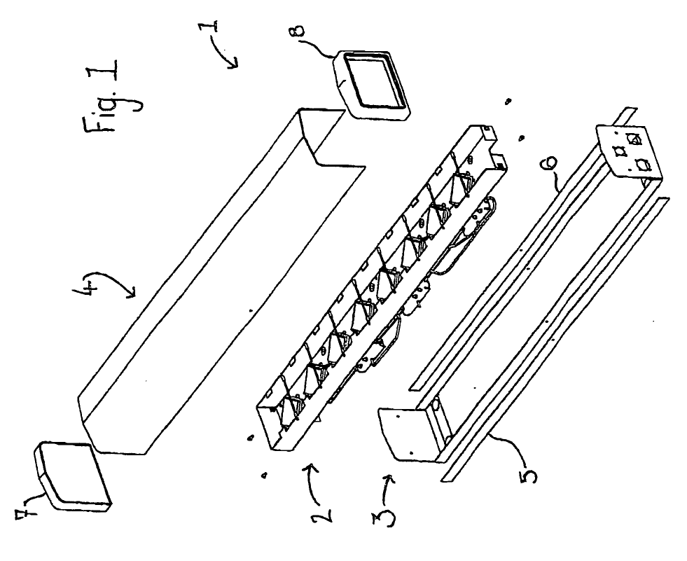

FIG. 1 is an isometric exploded view of an antenna.

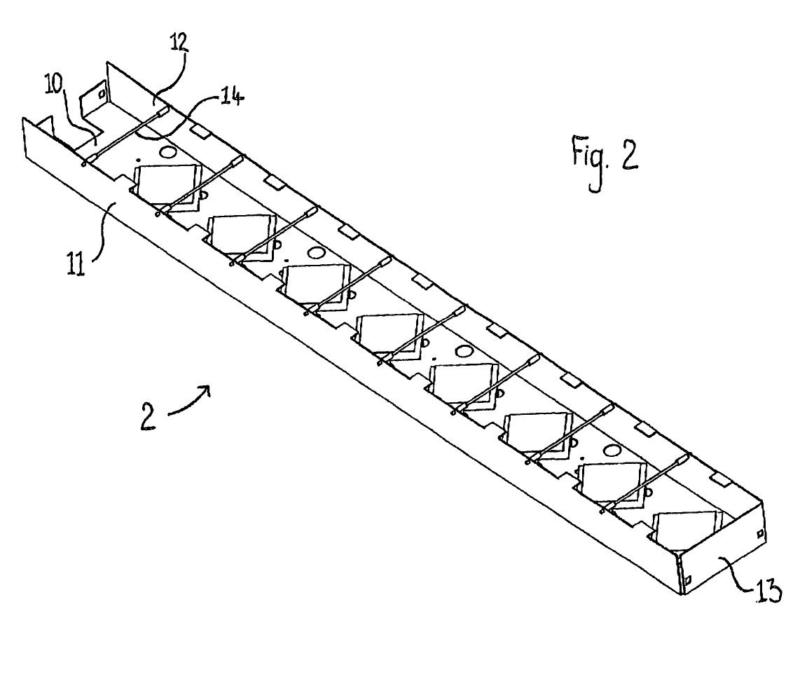

FIG. 2 is an isometric view of the patch tray assembly shown in FIG. 1.

FIG. 2a is a plan view of the patch tray assembly.

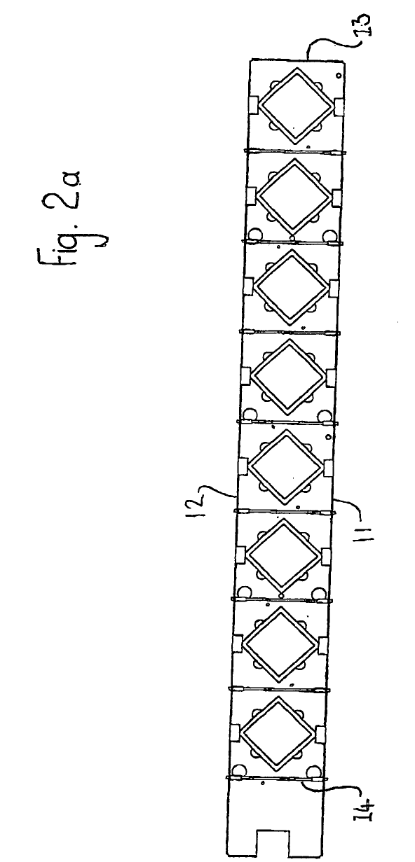

FIG. 3 is an enlarged isometric view of one end of the patch tray assembly.

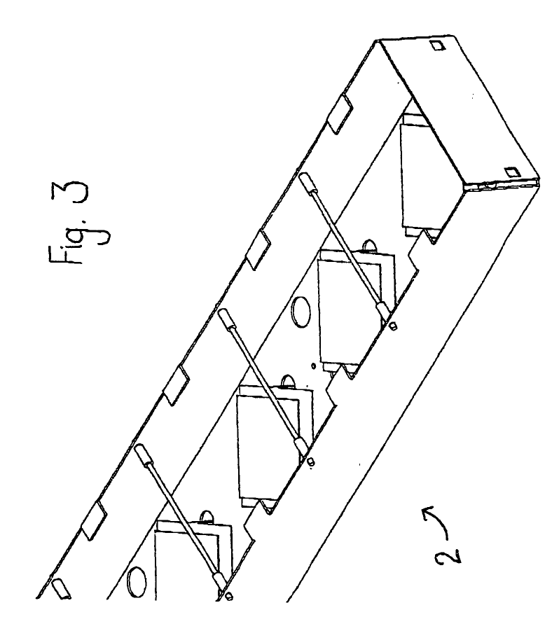

FIG. 4 is a plan view of three of the patches.

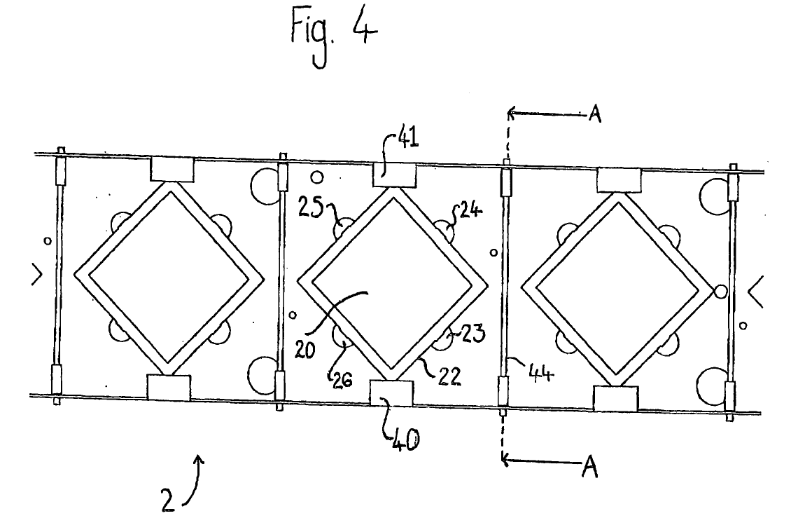

FIG. 5 is a cross-section taken along a line A-A in FIG. 4.

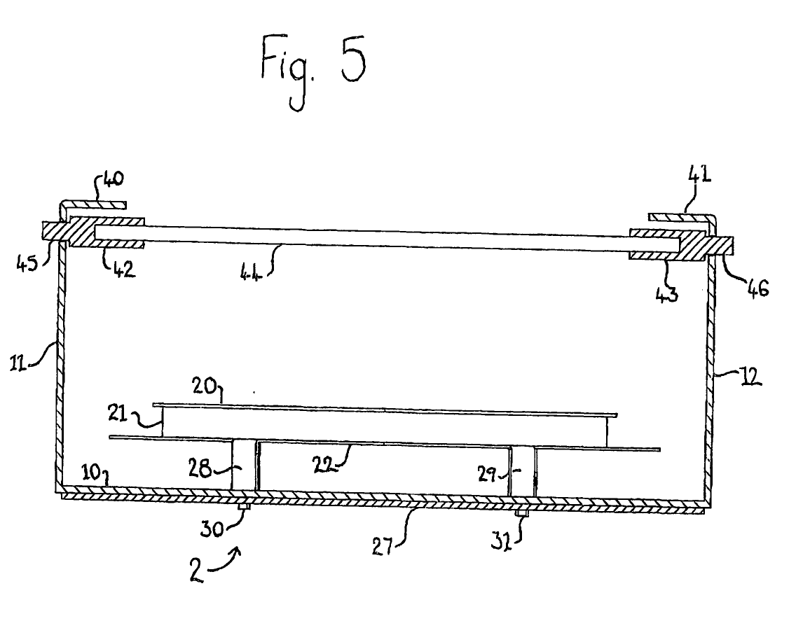

FIG. 6 is an isometric view of an alternative patch tray assembly.

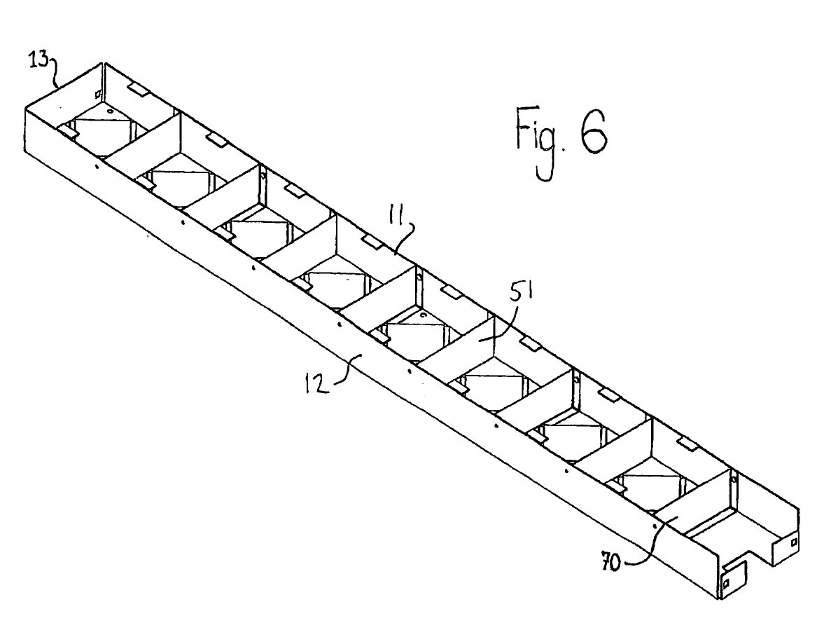

FIG. 7 is an enlarged isometric view of one end of the patch tray assembly of FIG. 6.

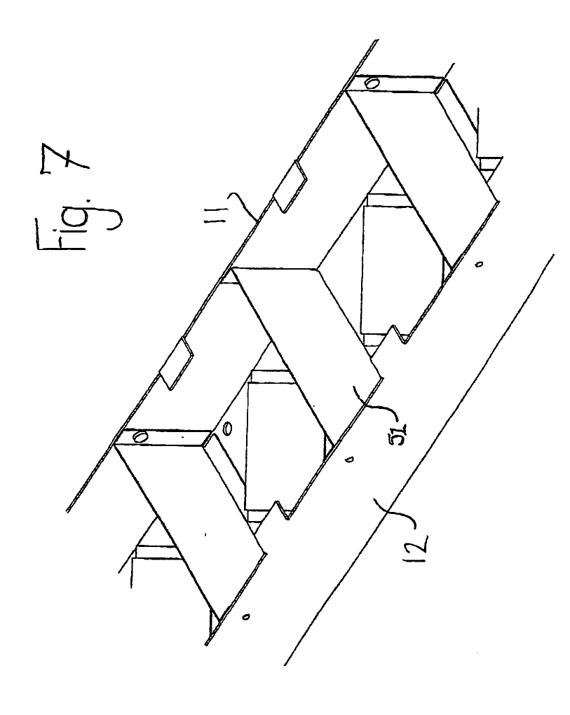

FIG. 8 is plan view of two of the patches of FIG. 6.

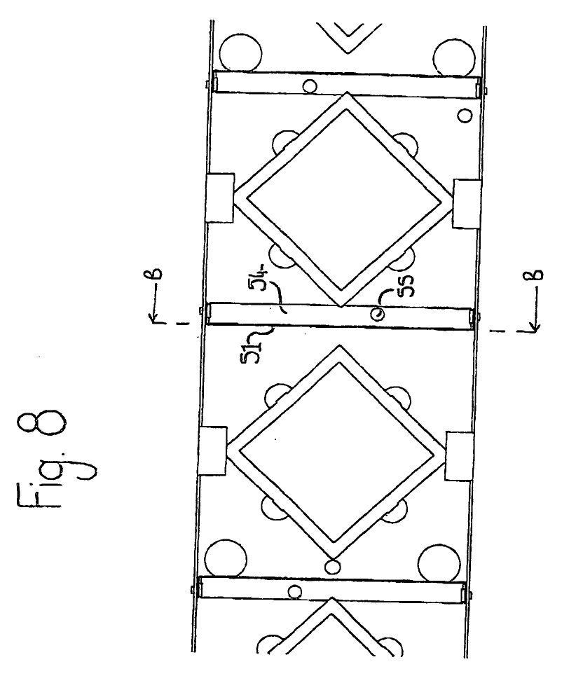

FIG. 9 is a cross-section taken along a line B-B in FIG. 8.

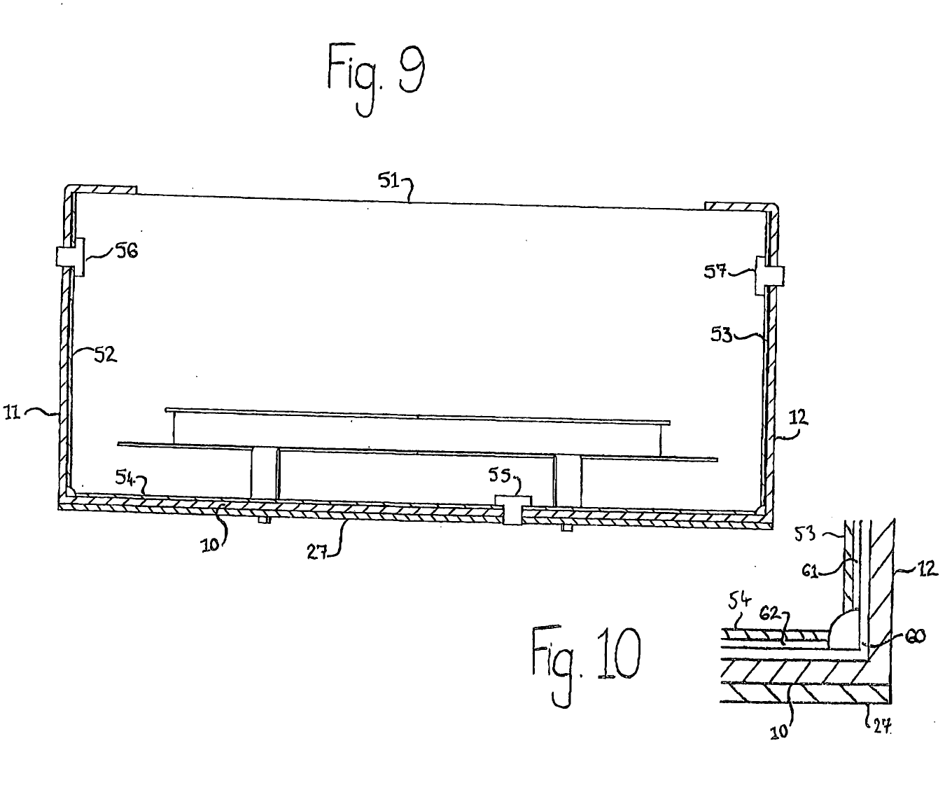

FIG. 10 is an enlarged schematic cross-section through a corner of the patch tray assembly shown in FIG. 9.

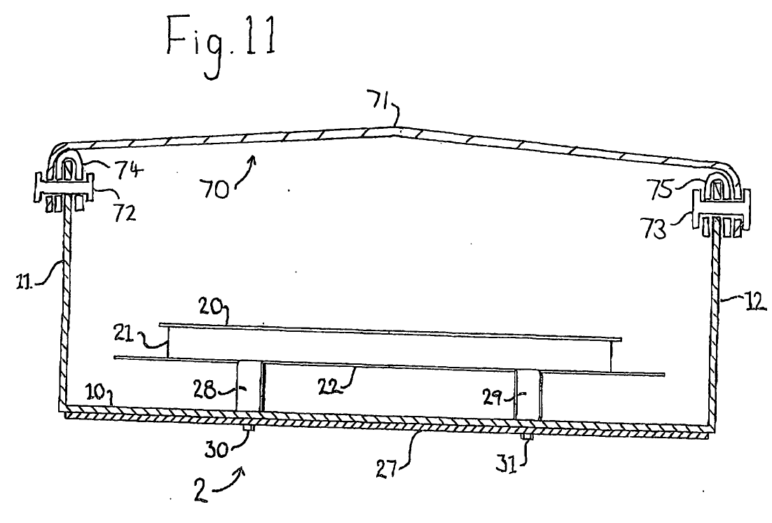

FIG. 11 is a cross-section through an alternative patch tray assembly showing a strip isolating element.

Referring to the first embodiment shown in FIGS. 1-5, an antenna assembly 1 is formed by a patch tray assembly 2 including a line of patch radiating elements (shown in detail in FIGS. 2-5); a secondary tray 3 which is fixed to the patch tray assembly 2 by screws or other fixing means; a radome 4 which is fixed to the secondary tray 3 by strips of double-sided adhesive tape 5,6: and a pair of end caps 7,8 which fit over the ends of the assembly. The assembly 1 is mounted, when in use, on a mast with the line of radiating elements oriented vertically.

Referring to FIGS. 2-5, the patch tray assembly 2 includes a tray formed by folding a planar aluminium sheet to provide a back reflector 10, left side wall 11, right side wall 12 and end wall 13. Eight patch radiating elements are mounted in a single line on the reflector 10. The elements are identical and one is shown in cross-section in FIG. 5. A square top patch 20 (which may be brass or another conductive material) is attached to a block 21 of insulating foam material by a layer (not shown) of double-sided adhesive tape. The block 21 is attached to a square brass bottom patch 22 by another layer (not shown) of double-sided adhesive tape. A printed circuit board (PCB) 27 is attached to the back of the reflector 10 by adhesive (not shown). The back reflector 10 has four holes 23-26 partially shown in plan view in FIG. 4 and the PCB 27 also has holes (not shown) lying in register with the holes 23-26. The bottom patch 22 has four feed probes which pass through the holes 23-26. Two of the feed probes are shown at 28,29 in FIG. 5. The probes have tabs which pass through to the rear of the PCB 27 (two of the tabs 30,31 being shown in FIG. 5) and are connected via solder (not shown) to feed lines (not shown) printed on the rear side of the PCB 27. The feed lines are also connected to a set of phase shifters which are partially shown in FIG. 1 mounted to the rear of the patch tray assembly. The phase shifters introduce phase shifts between the signals provided to the radiating elements in order to control downtilt of the antenna beam.

The side walls 11,12 each support eight rectangular tabs which are each aligned with the centre of a respective patch radiating element. Two of the tabs 40,41 are shown in cross-section in FIG. 5. The tabs 40,41 are formed by folding the same sheet of metal as the side walls 11,12 and act as isolating elements. The tabs 40,41 subtend an angle of 90 degrees with the inner face of the side walls 11,12.

Eight additional isolating elements are suspended between the side walls 11,12. One of the elements is shown in detail in FIG. 5. A pair of insulating plastic bushes 42,43 carry a cylindrical rod 44 formed of aluminium or another conductive material. The bushes 42,43 each have stubs 45,46 which fit through holes in the side walls 11,12. As shown in FIG. 4, the rods bisect a line joining the centres of the adjacent patch radiating elements.

In an alternative embodiment (not shown) the cylindrical rods may be replaced by flat strips with a planar surface lying parallel with the reflector 10. These strips may be welded to the side walls 11,12 or insulated from the side walls by insulating elements.

An alternative patch tray assembly is shown in FIGS. 6-9. Integers which are equivalent to integers in FIGS. 1-5 are given the same reference numerals. The rods are replaced by alternative isolating elements, one of which is shown in detail in FIGS. 7-9. The element is formed by folding a planar sheet of brass to form a wall 51 transverse to the reflector 10 and side walls 11,12, a pair of side walls 52,53 (labelled in FIG. 9) parallel with the side walls 11,12 and a rear wall 54 parallel with the back reflector 10. The element is secured to The tray by a plastic insulating rivet 55 passing through the rear wall 54, reflector 10 and PCB 27; a plastic insulating rivet 56 passing through the side wall 52 and side wall 11; and a plastic insulating rivet 57 passing through the side wall 53 and side wall 12.

Prior to folding to form the reflector 10 and side walls 11,12, the aluminium sheet is powder coated with an electrically insulating layer 60 shown in FIG. 10 (which is not to scale). Strips of single sided electrically insulating tape are also secured to the side walls 52,53 and back wall 54. Two of the strips 61,62 are shown in FIG. 10. The tape and powder layers prevent a direct electrical connection between the walls 52,53,54 and the tray.

In an alternative arrangement (not shown), powder coating of the reflector 10 and side walls 11,12 may not be necessary.

An alternative isolating element is shown in FIG. 11. A flat metallic strip 70 is bent upwardly to form a ridge 71 at its central point and attached at both ends to the side walls 11,12 by plastic rivets 72,73 passing through insulating clips 74,75.

In an alternative arrangement (not shown), the strip 70 may be bent downwardly to form a trough at its central point.

The antenna is mounted vertically in use at a cellular telecommunication base station. The patch radiating elements transmit and receive signals at +45 degrees and −45 degrees polarisation which are fed to/from the antenna via respective polarisation ports (not shown). The −3 dB beamwidth of the antenna is reduced to approximately 65 degrees by the side walls 11,12. The antenna typically works in a cellular telecommunication band such as 1710-1880 MHz, 1750-1990 MHz or 1900-2170 MHz, but could be reasonably expected to work anywhere between 400 and 3000 MHz.

Isolation between the different polarisation ports is improved by the isolating elements positioned between the radiating elements and by the tabs mounted on the side walls. It has also been found that isolation is improved in some cases by including isolating elements at the top and bottom of the array—that is, by including the rod 14 and end wall 13 shown in FIGS. 2 and 2a, or by including the wall 70 and end wall 13 shown in FIG. 6.

As shown in FIGS. 4 and 8, each radiating element faces a side wall on its left and right side, and an isolation element on its upper and lower side. The linearly polarised +45 degree and −45 degree electromagnetic waves transmitted by the array have horizontal components which are equal in amplitude. The symmetrical construction is designed to maintain this equality, which results in improved isolation. The symmetry is increased further by ensuring that the side walls 11,12 and isolation elements are all spaced equally from the centre of the radiating elements (resulting in a square configuration).

We have found that the gap between the side walls 52,53 of the isolating element 50 and the side walls 11,12 of the tray is particularly critical to the operation of the antenna. This spacing can be accurately controlled by suitable selection of the thickness of the powder layer 60 and tape 61,62. We have found that the rods in the first embodiment do not need to be so close to the side walls, so can be spaced further away by the insulating bushes 42,43. The arrangement of FIGS. 1-6 does not require powder coating of the tray to prevent direct electrical connection with the rods.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope of the invention as defined in the appended claims.

1. A dual polarisation antenna comprising:
one or more radiating elements;
a pair of side walls arranged on opposite sides of the radiating element(s); and
one or more conductive isolating elements, each isolating element being at least partially supported by one or both of the side walls.

2. An antenna according to claim 1 wherein at least one of the isolating elements is supported by one of the side walls only.

3. An antenna according to claim 2 wherein the isolation element is a substantially rectangular tab.

4. An antenna according to claim 2 wherein the isolation element subtends an angle of less than 180 degrees with the inner face of its supporting side wall.

5. An antenna according to claim 1 wherein at least one of the isolation elements is formed integrally with its supporting side wall(s).

6. An antenna according to claim 1 wherein at least one of the isolation elements subtends an angle between 80 and 100 degrees with the inner face of its supporting side wall.

7. An antenna according to claim 1 wherein at least one of the isolating elements is supported by both side walls.

8. An antenna according to claim 1 including an insulating element arranged between an isolating element and its supporting side wall.

9. An antenna according to claim 8 wherein the insulating element passes through a hole formed in the supporting side wall.

10. An antenna according to claim 1, comprising two or more radiating elements, each radiating element having first and second opposite sides, and third and fourth opposite sides; and
three or more isolating elements, wherein the side walls and isolating elements are positioned such that each radiating element faces a side wall on its first side, a side wall on its second side, an isolating element on its third side, and an isolating element on its fourth side.

11. An antenna according to claim 1 wherein at least one of the isolating elements comprises a rod with a substantially circular cross-section.

12. An antenna according to claim 1 wherein at least one of the isolating elements is fully supported by one or both of the side walls.

13. An antenna according to claim 1 wherein the side walls and radiating elements are arranged in front of a planar reflector.

14. An antenna according to claim 1 wherein at least one of the isolating elements comprises a wall.

15. An antenna according to claim 14 wherein the wall is connected on a first side to the planar reflector, on a second side to one side wall, and on a third side to the other side wall.

16. An antenna according to claim 1 wherein each radiating element is a patch.

17. An antenna according to claim 1 wherein the side walls are substantially continuous.

18. An antenna according to claim 1 comprising a plurality of radiating elements.

19. An antenna according to claim 18 further comprising one or more phase shifters for generating a relative phase difference between two or more of the radiating elements.

20. An antenna according to claim 18 wherein at least one of the isolating elements is positioned between adjacent radiating elements.

21. An antenna according to claim 1 wherein at least one of the isolating elements is aligned with a respective radiating element.

22. An antenna according to claim 1 wherein at least one of the isolating elements is formed with a ridge or trough between the two side walls.

23. A dual polarisation antenna comprising:
one or more radiating elements;
a pair of side walls arranged on opposite sides of the radiating element(s); and
one or more walls transverse to the side walls, wherein the or each transverse wall comprises a conductive sheet which is folded at each side to form a pair of connection walls, and wherein each connection wall is secured to a respective side wall.
